(19) United States
(12) Patent Application Publication
(10) Pub. No.: US 2017/0114878 A1
(43) Pub. Date: Apr. 27, 2017

(54) MULTI-LINK ROTATION STRUCTURE

(71) Applicant: MING-SHIH HUANG, Yunlin County (TW)

(72) Inventor: MING-SHIH HUANG, Yunlin County (TW)

(21) Appl. No.: 15/285,838

(22) Filed: Oct. 5, 2016

(30) Foreign Application Priority Data
Oct. 27, 2015 (TW) 104135370

(51) Int. Cl. F16H 21/12; F16H 29/12

(52) U.S. Cl. CPC F16H 21/12; F16H 29/12

(57) ABSTRACT

A multi-link rotation structure is provided, including: a base; two arm assemblies, each of the two arm assemblies including a pivot portion pivoted to the base and at least two arms connected with the pivot portion and extending away from each other, the pivot portions of the two arm assemblies being non-coaxial; at least two unidirectional rotation devices, respectively axially pivoted to the at least two arms of one of the two arm assemblies, rotatable in a same direction; at least two linkage assemblies, each of the at least two linkage assemblies pivoted to the at least two arms of the other of the two arm assemblies and pivoted to one of the at least two unidirectional rotation devices.

### BACKGROUND OF THE INVENTION

1. Field of the Invention

The present invention relates to a multi-link rotation structure.

2. Description of the Prior Art

Many devices and machines are equipped with connectors and transmission mechanisms such as gears, chains or multi-link mechanisms. Through the gears, chains or multi-link mechanisms, the devices and machines such as engines, motors, blowers or the like can output power for external uses (such as driving of actuators, wheels or generators, and thus it is very important in many fields.

However, the aforementioned conventional connector or transmission mechanism is connected between a driving device and a driven device, and is merely a mediate power transmission mechanism. The arrangement of the aforementioned conventional connector or transmission mechanism is generally restricted by installation space for the driving device and driven device and/or motion conditions (such as rotation speed or stroke). How to reduce energy loss of using the aforementioned conventional connector or transmission mechanism and How to ensure efficient operation and efficiently output power have been long-termed unsolved problems.

The present invention has arisen to mitigate and/or obviate the afore-described disadvantages.

### SUMMARY OF THE INVENTION

The major object of the present invention is to provide a multi-link rotation structure, using a multi-link mechanism and unidirectional rotation devices are used to achieve unidirectional rotation to provide output power; being simple in structure, easy to assemble, of low cost, and suitable for installation in many places.

To achieve the above and other objects, a multi-link rotation structure is provided, including: a base; two arm assemblies, each of the two arm assemblies including a pivot portion pivoted to the base and at least two arms connected with the pivot portion and extending away from each other, the pivot portions of the two arm assemblies being non-coaxial; at least two unidirectional rotation devices, respectively axially pivoted to the at least two arms of one of the two arm assemblies, rotatable in a same direction; at least two linkage assemblies, each of the at least two linkage assemblies pivoted to the at least two arms of the other of the two arm assemblies and pivoted to one of the at least two unidirectional rotation devices.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferred embodiment of the present invention;

FIG. 2 is a breakdown view of the preferred embodiment of the present invention;

FIG. 3 is a front view of the preferred embodiment of the present invention;

FIGS. 4-7 show various preferred embodiments of the present invention; and

FIG. 8 is a stereogram of another preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

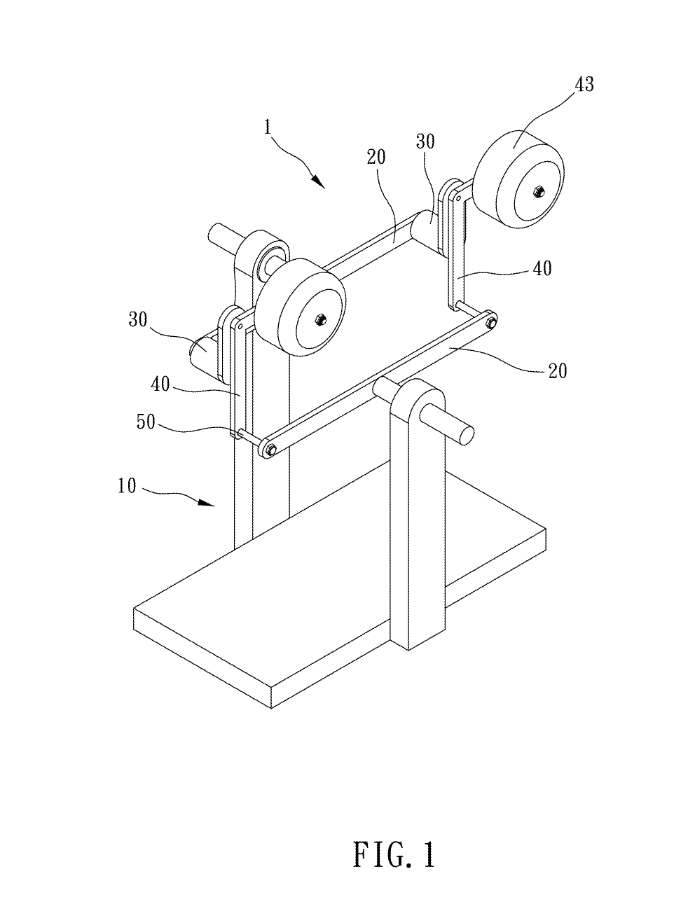

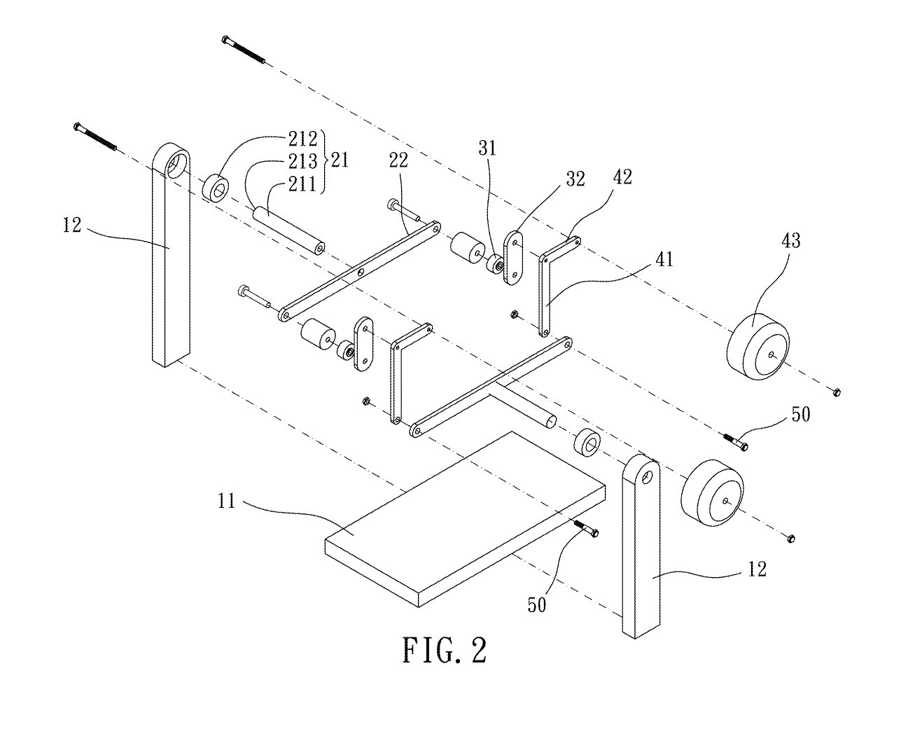

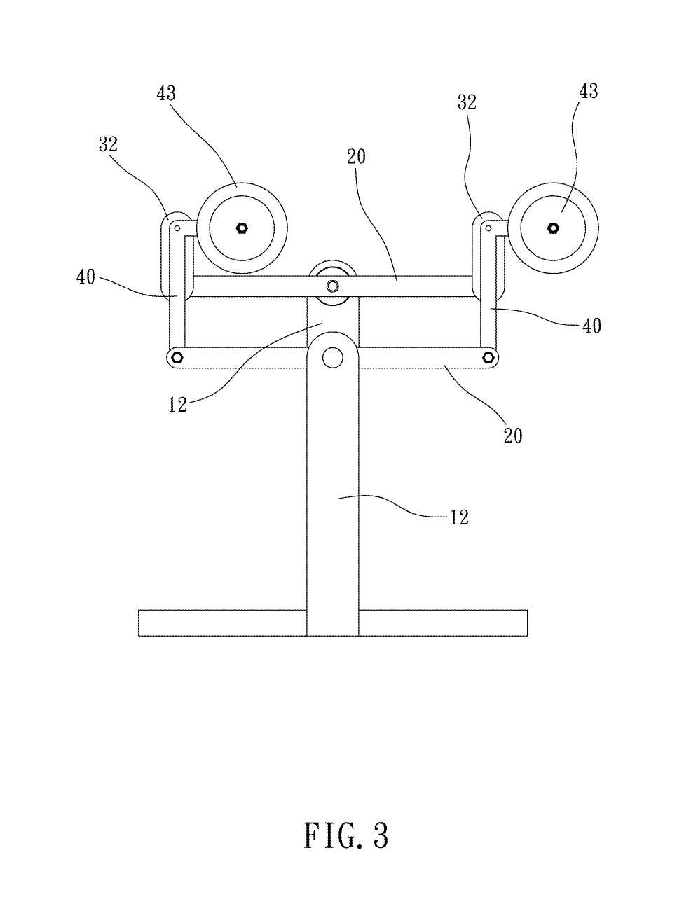

Please refer to FIGS. 1 to 3 for a preferred embodiment of the present invention. A multi-link rotation structure 1 includes a base 10, two arm assemblies 20, at least two unidirectional rotation devices 30 and at least two linkage assemblies 40.

Each of the two arm assemblies 20 includes a pivot portion 21 pivoted to the base 10 and at least two arms 22 connected with the pivot portion 21 and extending away from each other (preferably oppositely extending from the pivot portion 21). The pivot portions 21 of the two arm assemblies 20 are non-coaxial. The at least two unidirectional rotation devices 30 are respectively axially pivoted to the at least two arms 22 of one of the two arm assemblies 20 and rotatable in a same direction. Each of the at least two linkage assemblies 40 is pivoted to the at least two arms 22 of the other of the two arm assemblies 20 and pivoted to one of the at least two unidirectional rotation devices 30. Whereby, as at least one of the arms 22 receives a force (such as hand loading, mechanical force input, additional weight, magnetic force, fluid (such as air or water) force), the multi-link rotation structure 1 can be rotated to generate torque and output power. Additionally, the pivot portions 21 may cooperate with a reduction mechanism and the unidirectional bearing to apply required force to the arms 22, so that it requires less force to overcome inertia of the multi-link rotation structure, and the two arm assemblies 20 are rotated. The unidirectional bearing reduces friction of parts, thus improving the output power.

Specifically, the base 10 includes a base member 11 and two posts 12 spaced apart from each other and disposed on the base member 11. The two posts 12 are preferably arranged to be axially aligned with each other, but not limited thereto. Each of the pivot portions 21 of the two arm assemblies 20 is pivoted to one said post 12. Preferably, the pivot portions 21 of the two arm assemblies 20 are arranged in a high-low manner. However, the pivot portions 21 of the two arm assemblies 20 may be pivoted to the post as long as the two arm assemblies 20 will not be stuck with each other. Each of the pivot portions 21 of the two arm assemblies 20 includes an axle 211 and a bearing 212 disposed around the axle 211, and the bearing 212 is attached to one of the two posts 12, and thus the bearing 212 can minimize rotational friction of the axle 211. In this embodiment, each of the two arm assemblies 20 includes two of the arms 22, the two arms 22 extend oppositely at an angle of 180 degrees, and the two arm assemblies 20 are parallel to each other. Preferably, each of the pivot portions 21 further include a power-output connection mechanism 213, and the power-output connection mechanism 213 may be spline teeth, socket, gear, connection rod, coupling or the like. The power-output connection mechanism 213 is for external connection of a driven device (such as a generator, wheel or any rotatable mechanism), for driving the driven device.

Each of the at least two unidirectional rotation devices 30 includes an unidirectional bearing 31 which is axially pivoted to one said arm 22 of one of the two arm assemblies 20 and a connecting member 32 which is pivoted to the unidirectional bearing 31 and one of the at least two linkage assemblies 40, and the unidirectional bearing 31 and a portion of the arm 22 pivoted with the linkage assembly 40 are non-coaxial. The axes of the at least two unidirectional bearings 31 are substantially in parallel. The at least two unidirectional rotation devices 30 may be ratchets or/and ratcheting members. It is noted that the at least two unidirectional rotation devices 30 may be connected directly to the unidirectional bearing of one said arm 22 without any connecting member.

Each of the at least two linkage assemblies 40 includes a linking section 41 which is pivoted to one said arm 22 of one of the two arm assemblies 20 and pivoted to one of the at least two unidirectional rotation devices 30 and includes an extending section 42 transversely extending from the linking section 41, and the extending sections 42 of the two arm assemblies 42 extend substantially toward a same direction. The arms 22 of the two arm assemblies 20 and the linking sections 41 of the at least two linkage assemblies 40 form a four-bar mechanism. In this embodiment, each of the at least two linkage assemblies 40 further includes a weight 43. Preferably, each weight 43 is attached to the extending section 42, and the weights 43 of the at least two linkage assemblies 40 shift toward a same direction relative to respective portions of the at least two linkage assemblies 40 pivoted to the at least two unidirectional rotation devices 30. As a result, when a force or loading exerts on the multi-link rotation structure 1, the weight 43 can advantage the rotational inertia and torque of the multi-link rotation structure 1. It is noted that the greater the length of the extending section 42 is, the rotational inertia and torque of the multi-link rotation structure 1 are (even none of weight is required). The weight 43 may be a ball member such as a solid ball or a hollow ball with filler thereinside, but not limited thereto.

Specifically, the two unidirectional rotation devices 30 axially separate the two arm assemblies 20. Each of the at least two linkage assemblies 40 is connected between one said unidirectional rotation device 30 and one said arm assembly 20 using a pivot member 50. As a result, the at least two linkage assemblies 40 and the two weights 43 can move continuously between the two arm assemblies 20, without any interference. With restriction of the unidirectional rotation devices 30, the multi-link rotation structure 1 can rotate in one way.

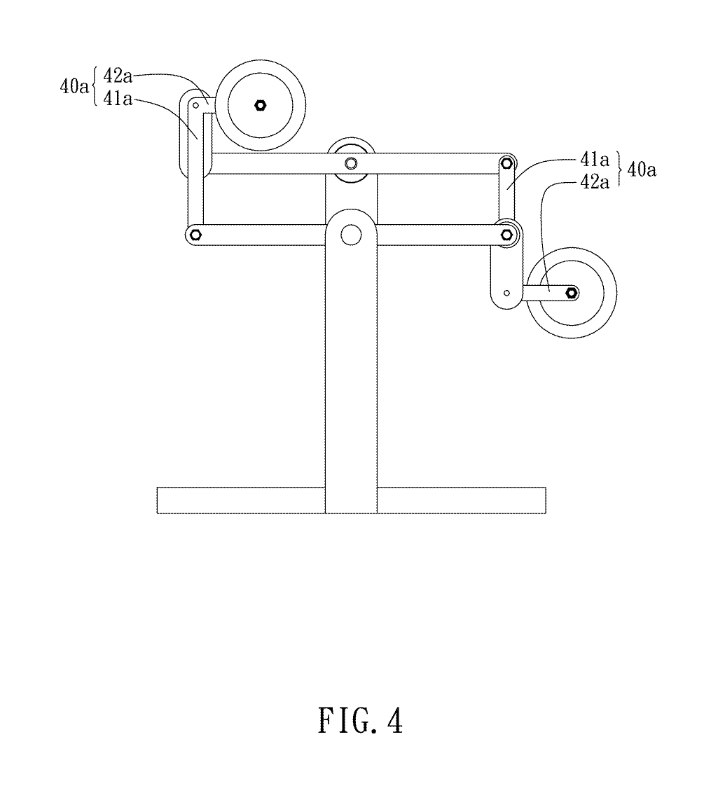

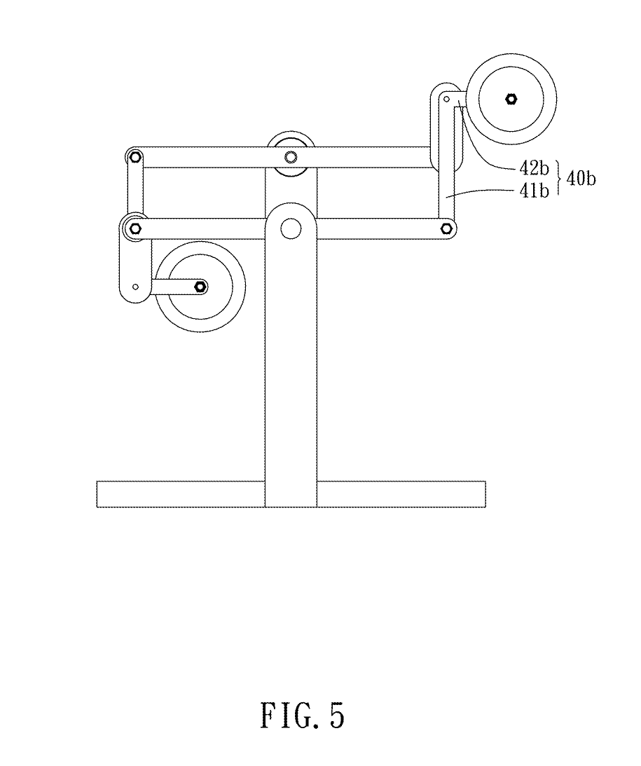

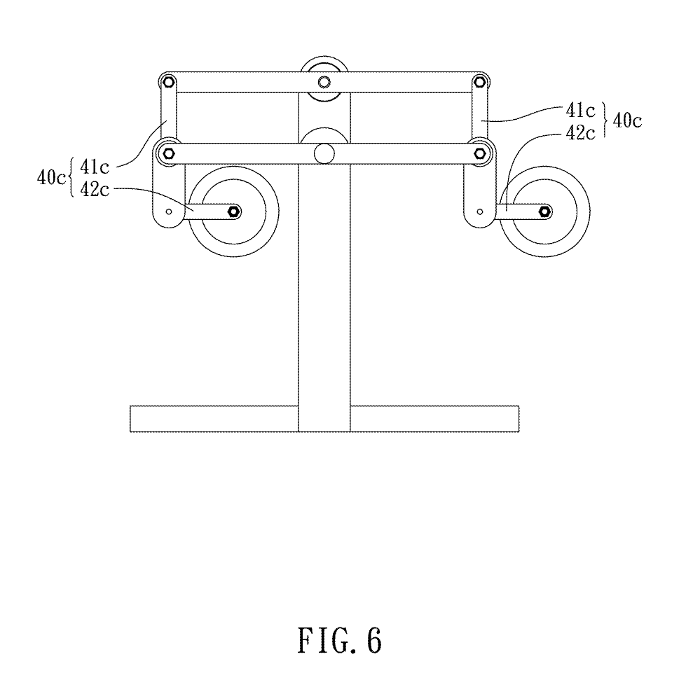

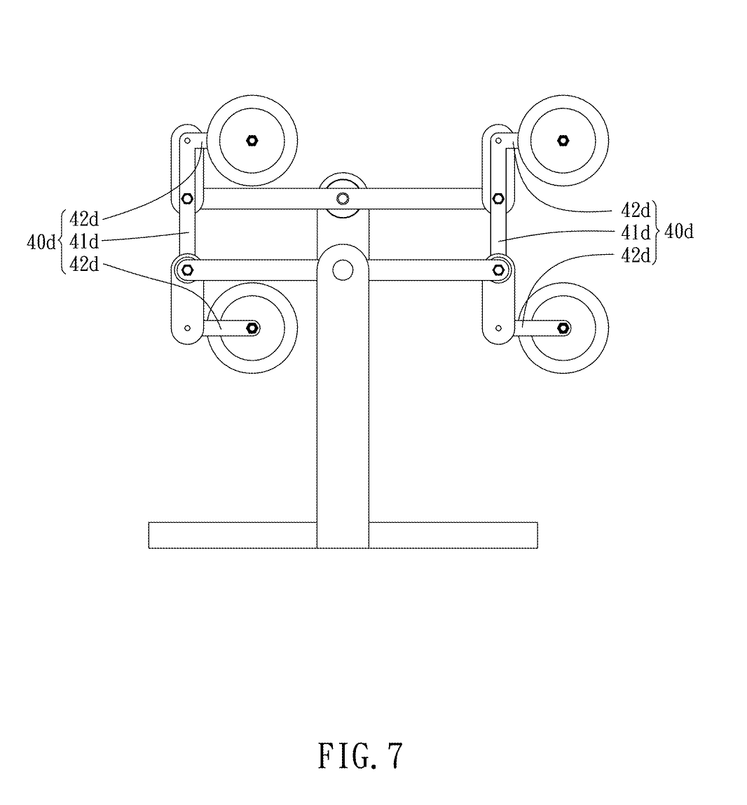

A multi-link rotation structure according to various embodiments of the present invent, two extending sections 42a of two linkage assemblies 40a are located at upper left and lower right sides of two linking sections 41a, respectively (as shown in FIG. 4); two extending sections 42b of two linkage assemblies 40b are located at lower left and upper right sides of two linking sections 41b, respectively (as shown in FIG. 5); two extending sections 42c of two linkage assemblies 40c are located at bottom side of two linking sections 41c (as shown in FIG. 6); each of two linking sections 41d of two linkage assemblies 40d has two extending section 42d extending from upper and lower ends thereof, respectively (as shown in FIG. 7) . It is noted that it requires that there is at least one couple of extending sections or that the extending sections are located at the same side.

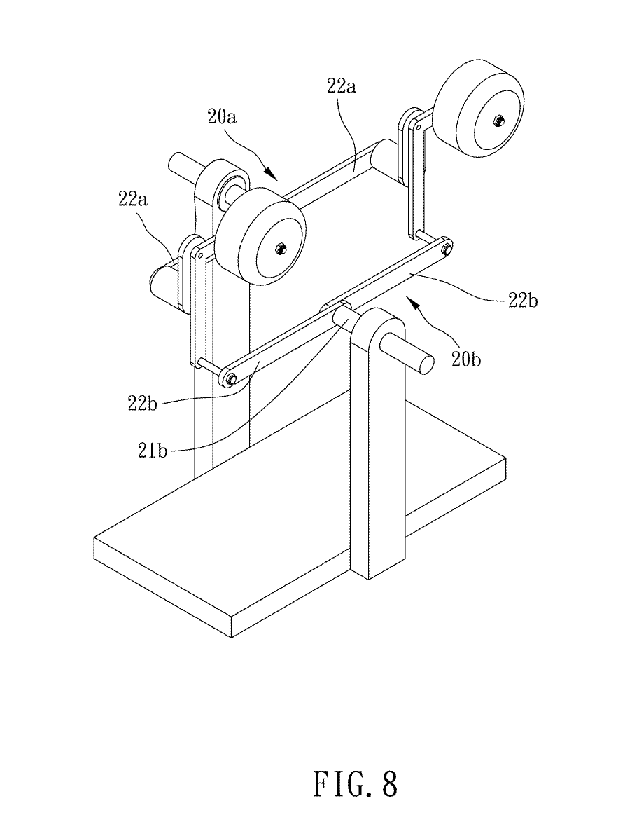

In an alternative embodiment as shown in FIG. 8, two arms 22a of an arm assembly 20a are integrally connected together (for example, formed in one piece), two arms 22b of another arm assembly 20b are not formed in one piece and respectively pivoted to two pivot portions 21b. The two arms 22b of the arm assembly 20b pivoted to the pivot portion 21b have a total length equal to a length of the two arms 22a of the two arm assemblies 20a. The two arms 22b have respective contacts and frictions with the pivot portion 21b, and the respective contacts and frictions do not affect each other, so forces on rotational mechanisms on two sides of the two arm assemblies 20a cannot impede each other, thus having good operation efficiency.

It is noted that, the multi-link rotation structure may include three or more arm assemblies, three or more unidirectional rotation devices and three or more linkage assemblies.

Given the above, the multi-link rotation structure uses a multi-link mechanism and unidirectional rotation devices to achieve unidirectional rotation, preferably with weights to increase rotational inertia and torque, to provide output power.

In addition, the multi-link rotation structure is simple in structure, easy to assemble, of low cost, and suitable for installation in many places.

While we have shown and described various embodiments in accordance with the present invention, it should be clear to those skilled in the art that further embodiments may be made without departing from the scope of the present invention.

What is claimed is:

1. A multi-link rotation structure, including:
a base;
two arm assemblies, each of the two arm assemblies including a pivot portion pivoted to the base and at least two arms connected with the pivot portion and extending away from each other, the pivot portions of the two arm assemblies being non-coaxial;
at least two unidirectional rotation devices, respectively axially pivoted to the at least two arms of one of the two arm assemblies, rotatable in a same direction;
at least two linkage assemblies, each of the at least two linkage assemblies pivoted to the at least two arms of the other of the two arm assemblies and pivoted to one of the at least two unidirectional rotation devices.

2. The multi-link rotation structure of claim 1, wherein the base includes two posts spaced apart from each other, and each of the pivot portions of the two arm assemblies is pivoted to one of the two posts.

3. The multi-link rotation structure of claim 2, wherein the pivot portions of the two arm assemblies are arranged in a high-low manner.

4. The multi-link rotation structure of claim 2, wherein each of the pivot portions of the two arm assemblies includes an axle and a bearing disposed around the axle, and the bearing is attached to one of the two posts.

5. The multi-link rotation structure of claim 1, wherein each of the two arm assemblies includes two of the arms extending oppositely at an angle of 180 degrees, and the two arm assemblies are parallel to each other.

6. The multi-link rotation structure of claim 1, wherein each of the at least two unidirectional rotation devices includes an unidirectional bearing which is axially pivoted to one said arm of one of the two arm assemblies and a connecting member which is pivoted to the unidirectional bearing and one of the at least two linkage assemblies, and the unidirectional bearing and a portion of the arm pivoted with the linkage assembly are non-coaxial.

7. The multi-link rotation structure of claim 1, wherein each of the pivot portions of the two arm assemblies includes a power-output connection mechanism, and the power-output connection mechanism is for external connection of a driven device.

8. The multi-link rotation structure of claim 1, wherein the at least two arms of one of the two arm assemblies are integrally connected together, and the at least two arms of the other of the two arm assemblies are not integrally connected together and respectively pivoted to the pivot portions of the two arm assemblies.

9. The multi-link rotation structure of claim 1, wherein each of the at least two linkage assemblies includes a linking section which is pivoted to one said arm of one of the two arm assemblies and pivoted to one of the at least two unidirectional rotation devices and includes an extending section extending laterally from the linking section, and the extending sections of the two arm assemblies extend substantially toward a same direction.

10. The multi-link rotation structure of claim 1, wherein each of the at least two linkage assemblies further includes a weight, and the weights of the at least two linkage assemblies shift toward a same direction relative to respective portions of the at least two linkage assemblies pivoted to the at least two unidirectional rotation devices.

11. The multi-link rotation structure of claim 3, wherein each of the at least two linkage assemblies further includes a weight, and the weights of the at least two linkage assemblies shift toward a same direction relative to respective portions of the at least two linkage assemblies pivoted to the at least two unidirectional rotation devices.

12. The multi-link rotation structure of claim 5, wherein each of the at least two linkage assemblies further includes a weight, and the weights of the at least two linkage assemblies shift toward a same direction relative to respective portions of the at least two linkage assemblies pivoted to the at least two unidirectional rotation devices.

13. The multi-link rotation structure of claim 6, wherein each of the at least two linkage assemblies further includes a weight, and the weights of the at least two linkage assemblies shift toward a same direction relative to respective portions of the at least two linkage assemblies pivoted to the at least two unidirectional rotation devices.

14. The multi-link rotation structure of claim 8, wherein each of the at least two linkage assemblies further includes a weight, and the weights of the at least two linkage assemblies shift toward a same direction relative to respective portions of the at least two linkage assemblies pivoted to the at least two unidirectional rotation devices.

15. The multi-link rotation structure of claim 9, wherein each of the at least two linkage assemblies further includes a weight, and the weights of the at least two linkage assemblies shift toward a same direction relative to respective portions of the at least two linkage assemblies pivoted to the at least two unidirectional rotation devices.
